(19) United States
(12) Patent Application Publication
(10) Pub. No.: US 2005/0246649 A1
(43) Pub. Date: Nov. 3, 2005

(54) Online/offline multimedia directory system

(76) Inventor: Gerita Susanna Wilhelm, Denver, CO (US)

Correspondence Address: Gerita Susanna Wilhelm, 3035 South Elmira Court, Denver, CO, 80231, US

(21) Appl. No.: 11/112,986

(22) Filed: Apr. 23, 2005

Related U.S. Application Data
(60) Provisional application No. 60/566,342, filed on Apr. 29, 2004.

(51) Int. Cl. G06F 17/00

(52) U.S. Cl. 715/762; 715/853; 707/1; 715/513; 715/500.1

(57) ABSTRACT

According to the invention, an integrated multimedia directory system permitting a user to access a multiplicity of web pages containing multimedia is disclosed. The system includes point and click control panel pages for a hierarchy of directory management levels such as a listing subscriber, an administrator, one or more levels of resellers, and a system manager. The multimedia directory system creates both an online version driven by a database and an offline version that uses a linked collection of HTML pages directly readable in a web browser without using a database. The offline version is created using a server-side publishing system. The multimedia directory system further includes a multimedia file authoring system that uses one or more pre-defined templates, an input file reader, an output file parameter interpreter, a multimedia file generator, and a file sender.

This application claims priority based on U.S. Provisional Patent Application Ser. No. 60/566,342 entitled “Online Directory,” filed 29 Apr. 2004.

### 1. BACKGROUND OF THIS DISCLOSURE

The present invention relates to a directory that can be accessed online using a web browser connected to the internet and can also be published and distributed for use offline when not connected to the internet. The present invention also relates to authoring and managing multimedia files such as video clips on a web page using a “point-and-click” template-driven interface. The present invention further relates to web content management systems that include a hierarchy of management interfaces with a hierarchy of privileges.

The internet, and more particularly, the worldwide web, can be used to access information, promote products and services, and conduct commercial transactions. Search engines are a popular tool for finding the most relevant pieces of information from the billions of pages available on the worldwide web. Directories are popular with users because they help organize the information on the web. Search engines such as Google™ give high placement to directories because of their popularity with web users. Therefore, it is desirable for companies to have their products and services listed in a directories in order to maximize exposure to web surfers.

In the early days of the internet, almost all web pages contained only text and static images, giving the appearance of a hyper-linked book. More recently, so-called “multimedia” files are being used on an increasing proportion of web pages. Some types of multimedia files produce moving images on a web page; examples of which are animated GIFs, JavaScripts, Java applets based on a technology developed by Sun Microsystems, and Flash files based on a technology sold and supported by Macromedia. Some types of multimedia files add sound to a web page; and example of which is a WAV file. Some types of multimedia files, such as AVI, Flash, Quicktime, RealVideo, and MPEG provide a combination of sound and motion to produce what we commonly refer to as “video.” Multimedia files allow an individual or organization to present information, products, and services in a way that can be more effective and attractive. Thus, multimedia is helping to allow the worldwide web to be used as a medium for both “lean forward” (e.g. learn while concentrating) and “lean back” (learn while relaxing) applications. An infomercial is a type of “lean back” application commonly associated with video that can be brought to the worldwide web using multimedia technology.

Initially, web pages were created using text editors that required the author to manually add HTML “tags” to a document. Today, numerous authoring systems have been developed to help ordinary computer users to be able to create web pages without needing to employ a web master. One of the easiest to use user interfaces is a so-called “point and click” approach where the creator of a web page selects pre-defined templates and then adds text based on pre-defined input fields. It is also known to use this template approach for authoring multimedia files and adding them to a web page.

Content management systems are web authoring systems that allow multiple people to work on a multi-page website together. Content management systems typically rely on a database to store the information to be presented on web pages. Content management systems typically have a management hierarchy with different permission levels granted to different individuals working on this collection of web pages. There is a tradeoff between having high flexibility and having high ease-of-use in a content management system. Current easy-to-use content management systems don't provide a point-and-click interface that allows higher-level users to configure the point-and-click screens for lower-level users, for example.

When a content management system is used to manage a directory, it is desirable to structure the system so that it can support the common web marketing business models. A multi-tiered management hierarchy should be capable of charging fees and apportioning revenues among listing subscribers, administrators, resellers, and system managers. Among the revenue models that are desirable to support are subscription models and so-called “pay-for-clicks” models in which listing subscribers or administrators pay only for the traffic that actually visits their directory or individual listing pages.

Although the internet is available in more and more places, it is not yet available everywhere or on all computer appliances. People continue to rely on print media even though they have access to a computing appliance such as a desktop computer, laptop computer, PDA, or mobile phone. There is a benefit if the same information that is online can also be published on in an electronic medium such as a CD-ROM or downloaded in a format that can be stored onto a computing appliance. One of the complexities in doing this is that web pages generated by a content management system are typically generated “on the fly” from a database. This database-oriented architecture cannot easily be replicated when publishing this website on an electronically readable medium or in a format that can be downloaded and played on an offline computing appliance. It is known to download an entire website. For example, U.S. Pat. No. 5,892,908 to Hughes, et al describes a method of extracting linked web pages. However, the configuration described by Hughes, et al is not optimized for multimedia directories and is not integrated into an online/offline multimedia directory system. More specifically, the system and method described by Hughes operates on the client side of the system.

Blogs are web logs that create further user interest in a web site or web directory because blogs have gained a reputation for providing unfiltered information directly from the author. Modern blog authoring systems can use “point-and-click” technology to make it easy for anyone to publish their thoughts.

Prior to the present invention, there was no effective way to provide an easy to use, integrated directory system that included point-and-click multimedia file authoring, point-and-click multimedia web page creation, multiple tiers of management hierarchy, and the ability to publish and access the same information in an internet-connected environment and on offline computing appliances. In addition, it was not known to integrate a point-and-click blog authoring and management capability into such a directory system. It was also not known to provide such a directory system with a point-and-click interface that allows someone higher in the management hierarchy to define fields that are then used by others lower in the system management hierarchy to provide supplemental information.

### 2. BRIEF DESCRIPTION OF THE DRAWINGS

The present disclosure is described in conjunction with the appended figures wherein:

FIG. 1 shows an online/offline multimedia directory system;

FIG. 2 shows a management hierarchy for an online/offline multimedia directory system;

FIG. 3 shows a multimedia file authoring system;

FIG. 4 shows an offline directory publishing system;

FIG. 5 shows a directory page;

FIG. 6 shows a listing page;

FIG. 7 shows a supplemental questions/answers page;

FIG. 8 shows a blog page;

FIG. 9 shows a listing subscriber control panel page;

FIG. 10 shows a multimedia file authoring control panel page;

FIG. 11 shows a blog management panel page;

FIG. 12 shows a supplemental questions/answers input panel page;

FIG. 13 shows an administrator control panel page;

FIG. 14 shows a supplemental questions/answers control panel page;

FIG. 15 shows a reseller control panel page; and

FIG. 16 shows a system manager control panel page.

### 3. DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It should be understood that various changes may be made in the function and arrangement of elements without departing from the spirit and scope of the invention as set forth in the appended claims.

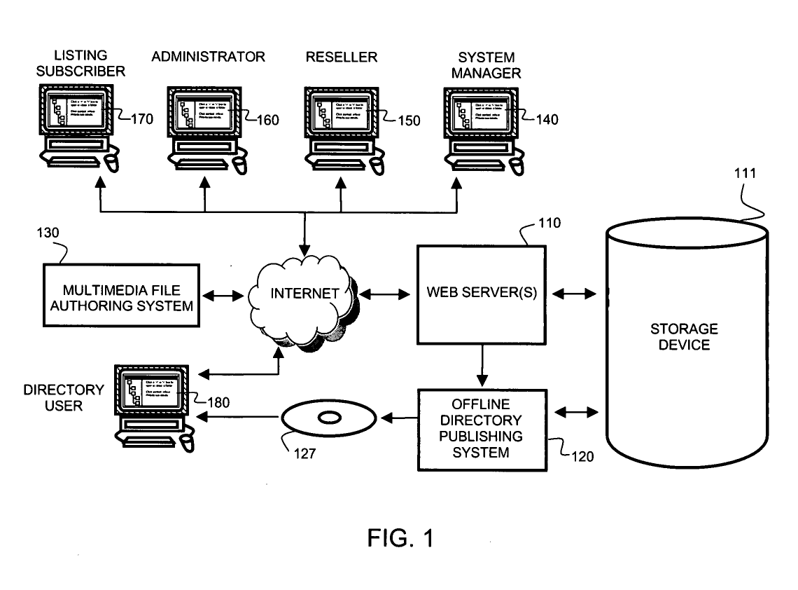

The online/offline video directory system shown in FIG. 1 includes the following elements:
a web server or web servers, shown at 110, connected to the internet;
a storage device or devices, shown at 111, connected to the web server(s) 110;
an offline directory publishing system, shown at 120, that is connected to the web server(s) 110 and the storage device(s) 110; and
a multimedia file authoring system, shown at 130, that is connected to the internet.

The web server 110 can be of any hardware and software configuration or combination, the details of which are known by anyone skilled in the art. For example, the web server 110 can be a system that runs the Linux operating system, using the Apache Web Server, and a program written in PHP. The web server 110 can be a system that runs the Microsoft Windows operating system, the Microsoft IIS web server in a dot net configuration using the Microsoft C# programming language. The web server 110 can be a system that runs the Sun Solaris operating system, using the Apache web server in conjunction with the Tomcat Java servlet container and the Java programming language.

The storage device 111 can be any computer storage device capable of interfacing with the web server 110 and the offline directory publishing system 120, the details of which are known by anyone skilled in the art. For example, the storage device 111 can be a hard disk drive system using a SQL database such as MySQL, Oracle 9i, IBM DB2, or Microsoft SQL server as well as individual files that store images, style sheets, templates, and multimedia. The storage device can be a hard disk drive that stores flat files containing data in a tab-delimited or comma separated format as well as individual files that store images, style sheets, templates, and multimedia.

The offline directory publishing system 120 takes commands from the web server 110 and information from the storage device 111 to generate a multimedia directory that can be published on a computer readable medium, shown at 127 or transmitted to a computer appliance. If the information is transmitted, it can be transmitted directly to the computer appliance or it can be transmitted to the computer appliance over an internet connection. Examples of computer readable media 127 that can be used include CD-ROMs, magnetic tape, removable hard disks, non-volatile semiconductor random-access memory and other media that are known by anyone skilled in the art.

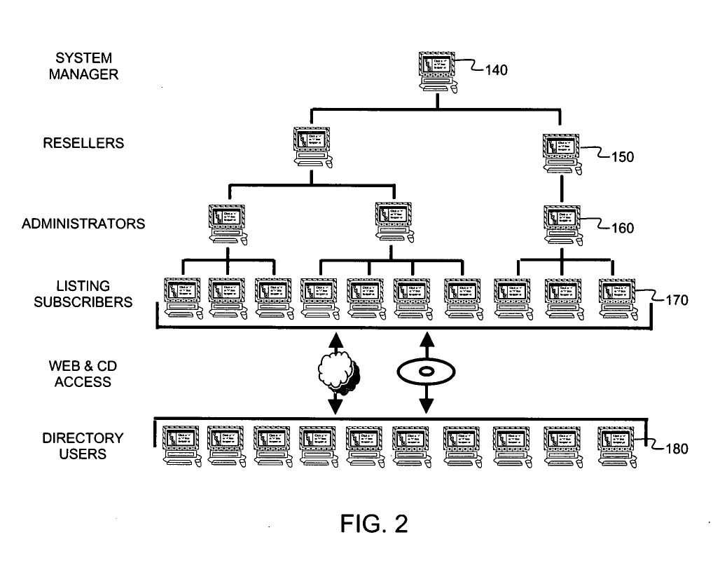

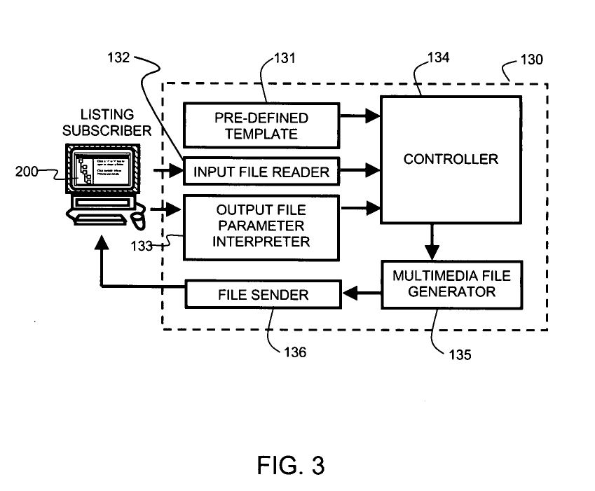

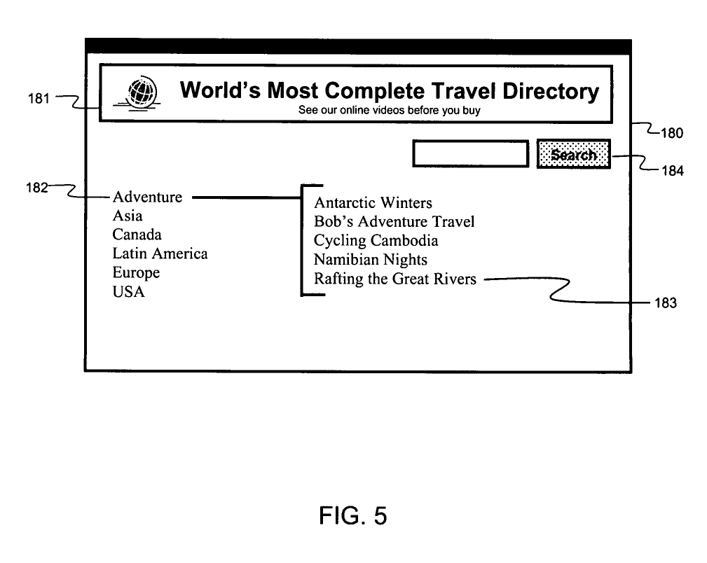

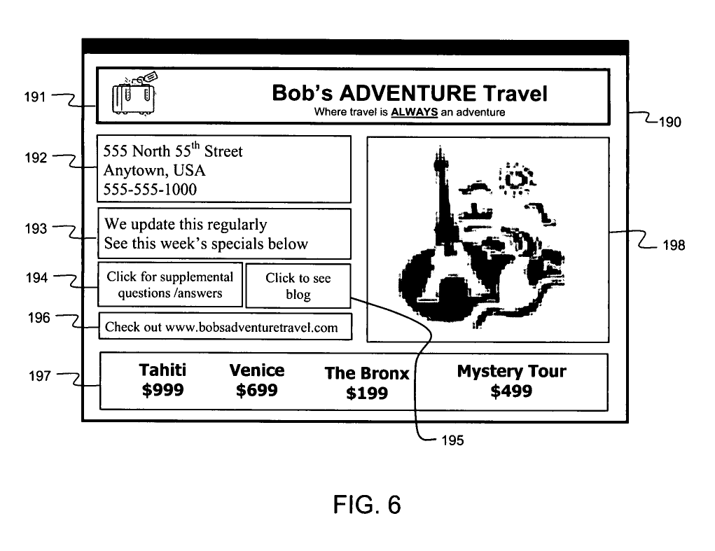

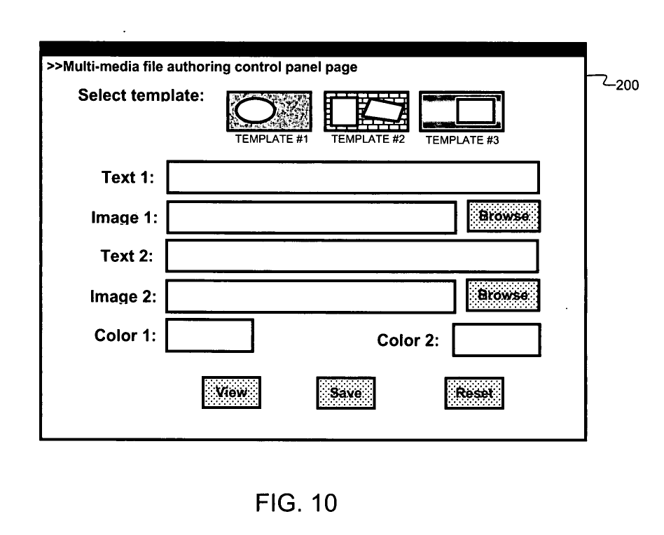

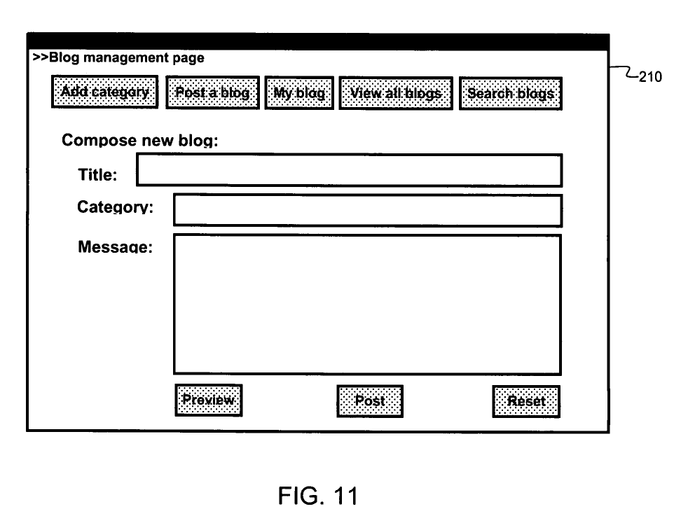

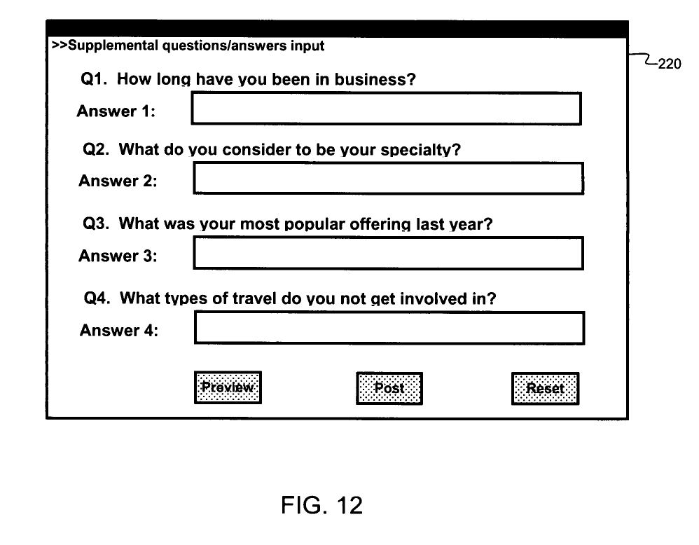

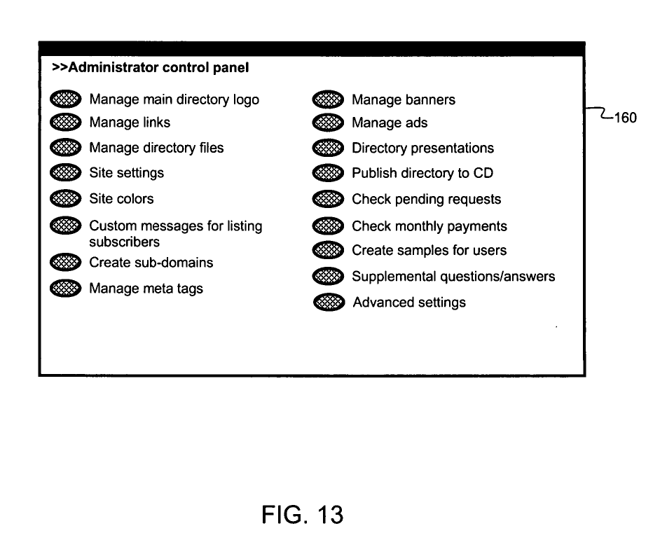

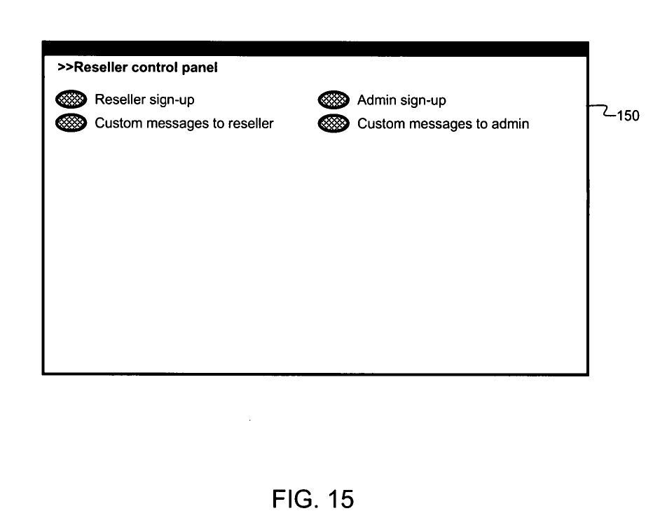

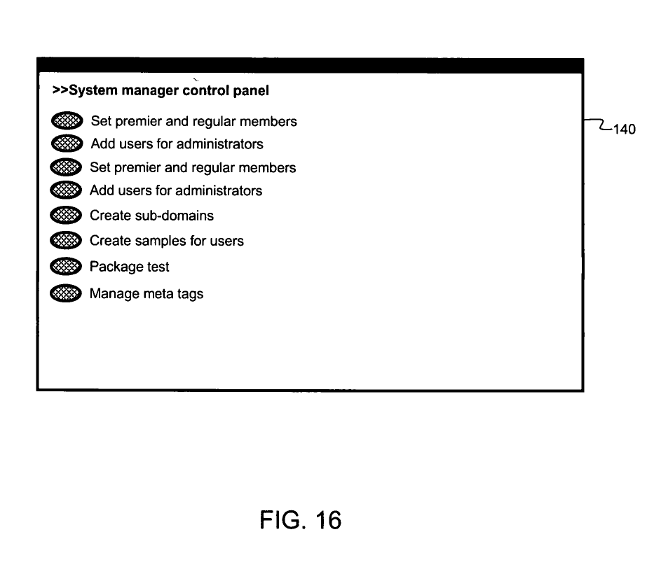

Different types of web pages are visible to different types of individuals accessing the multimedia directory system depending upon the access privileges that these individuals have. All users have access to directory user web pages such as a directory page, shown at 180 in FIG. 1 and FIG. 2. The directory page is shown in more detail at 180 in FIG. 5. Another type of directory use web page is the listing page shown in detail at 190 in FIG. 6. Listing subscribers, for example the individuals or organizations that pay a monthly subscription or a fee based on the traffic that visits their listing page(s) in the directory, also have access to listing subscriber pages such as the listing subscriber control panel page shown at 170 in FIG. 1 and FIG. 2. The listing subscriber control panel page is shown in more detail at 170 in FIG. 11. Another example of a listing subscriber page is the multimedia file authoring control panel page shown at 200 in FIG. 3 and shown in greater detail at 200 in FIG. 10. Further examples of listing subscriber pages are the blog management panel page shown at 210 in FIG. 11 and the supplemental questions/answers input panel page shown at 220 in FIG. 12. Administrators have access to all of the previously mentioned pages for their listing subscribers as well as administrator pages such as the administrator control panel page shown at 160 in FIG. 1 and FIG. 2. The administrator control panel page is shown in greater detail at 160 in FIG. 13. Resellers have access to all of the previously mentioned pages for their administrators as well as reseller pages such as the reseller control panel shown in at 150 in FIG. 1 and FIG. 2. The reseller control panel is shown in greater detail at 150 in FIG. 15. System managers have access to all pages as well as a system manager control panel page shown at 140 in FIG. 1 and FIG. 2. The system manager control panel page is shown in greater detail at 140 in FIG. 16.

Each web page can have its own unique internet address so that it can be individually found by a search engine. Each page can also have its own traffic statistics monitoring, so that the popularity of each page can be individually determined. These traffic statistics can also be aggregated based on any combination of pages desired.

Further referring to FIG. 2, the online/offline multimedia directory system can also incorporate more than one level of reseller. It is possible for a reseller to sell the system to another reseller. This allows for a variety of referral marketing methods and pricing schemes that are well understood by those skilled in this type of marketing. The entire system can be offered as a solution that is purchased for a fixed fee by the customer. The system can be offered in an application service provider (ASP) mode with regular fees on a monthly, quarterly, or annual subscription basis. The system can be offered based on the amount of traffic (clicks to a web page) that are generated. The system can be offered in any combination of these fees. The fees can be payable by the listing subscriber with the system generating profit for the administrator, any resellers, and the system manager. The fees can be payable by the administrator with usage by the listing subscriber being free. The fees can be payable by the computer user. The fees can be any other structure or combination that can be understood by anyone skilled in the art.

Referring to FIG. 3, a multimedia file authoring system is shown at 130. The multimedia file authoring system 130 includes a pre-defined template shown at 131. The pre-defined template 131 is a definition of how the information is to be presented. This can be a style file. This can be a combination of files with graphics and formatting information of a type and format that can be understood by anyone skilled in the art. The multimedia file authoring system 130 includes an input file reader, shown at 132. The input file reader 132 receives files that have been sent by a listing subscriber using a multimedia file authoring control panel, shown at 200, and shown in more detail at 200 in FIG. 10. Examples of the types of files an input file reader might process are JPG images, GIF images, WAV audio files, RAM audio files, MPEG video files, AVI video files, FLV video files, and MOV video files. The multimedia file authoring system 130 includes an output file parameter interpreter, shown at 133. The output file parameter interpreter 133 receives information that has been entered by a listing subscriber using a multimedia file authoring control panel, shown at 200, and shown in more detail at 200 in FIG. 10.

Further referring to FIG. 3, the information stored in the pre-defined template 131 and the information received by the input file reader 132 and by the output file parameter interpreter 133 are sent to a controller, shown at 134. The controller can be any computer program capable of combining parameters, files, and template or style information and organizing this into a format that can be read by a multimedia output file generator, shown at 135. The controller can be written in Microsoft Visual Basic. The controller can be written in Java from Sun Microsystems. It can be written in C# from Microsoft. The controller can be written in PHP. The controller can be written in any other computer language and can run on any computing device as determined by anyone skilled in the art. The key function of the controller is to format the input information in a format that can be interpreted by a multimedia output file generator 135. The multimedia output file generator 135 is typically an off-the-shelf program that takes a set of input instructions and files and combines these to make a single multimedia file or a collection of related multimedia files. The multimedia output file generator can be a GIF animation program such as Photoshop from Adobe. The multimedia output file generator can be a video generator such Flash MX from Macromedia, which generates FLV files. There are many different types of multimedia output file generator 135 programs available that are well understood by anyone skilled in the art.

Further referring to FIG. 3, the output from the multimedia file output generator 136 is passed to a file sender, shown at 136. The file sender 136 is a computer program that transmits the file or files generated by the output file generator 135 to the computing device used by a listing subscriber. The file or files can be transmitted as part of an email message. The file or files can be transmitted as a download or downloads that occur when a listing subscriber clicks on a web page. The file or files can be placed on a computer data storage medium and physically shipped to the listing subscriber. The file or files can be delivered to the listing subscriber by another other means capable of being understood by anyone skilled in the art.

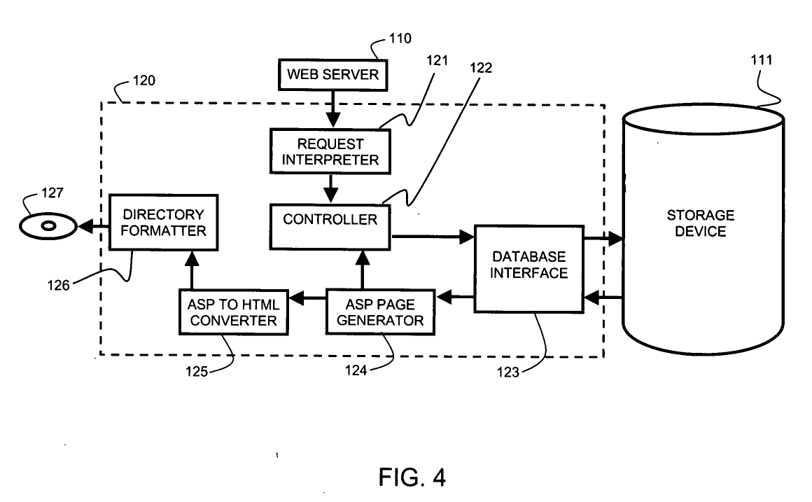

Referring to FIG. 4, an offline directory publishing system is shown at 120. The offline directory publishing system 120 operates on the server side of the internet connection. This allows the directory publishing system to be integrated with the other elements of the multimedia directory system, which also operate on the server side. The offline directory publishing system 120 receives its instructions from a web server or web servers, shown at 111. These instructions are received by a request interpreter, shown at 121. The request interpreter 111 is a computer program that converts the parameters and instructions given by the web server(s) 111 into a format that can be used by a controller, shown at 122 to start a cycle of requests and responses that converts a set of database-oriented web pages to a set of database-independent web pages. In the system shown in FIG. 4, the pages are initially produced in ASP (active server pages) format, a format developed and supported by Microsoft, through a database interface to a SQL Server database operating on the storage device shown at 111. The database interface, shown at 123 manages these transactions and passes the resulting pages to the ASP page generator, shown at 124. The ASP generator 124 tracks the pages that have been created and sends page reference information to the controller 122. The ASP page generator 124 sends the page content to an ASP to HTML converter shown at 125. The HTML converter 125 transforms the pages from ASP format, which can require a special program from Microsoft not found in most client computers to interpret part of the page information, into HTML format that can be read in the web browsers found on most computers without requiring a server-side ASP interpreter or database to be installed on this client side computer. Although the reference implementation shown in FIG. 4 is based on conversions to ASP and then to HTML, it is also possible to structure a directory publishing system based on conversions to PHP and then to HTML, or a system that does conversions to JSP and then to HTML, or a system that does conversions to any other server-side format that can then be converted to HTML. It is also possible to make the conversions to another web page description language that can be understood by a typical computer browser. In all cases, the web page description language allows the offline version of the directory to be readable in a computer browser that is offline, that is without needing the computing appliance to be connected to the internet and without the computing appliance needing to have a database installed. The alternative methods for doing this conversion process can be derived from FIG. 4 by anyone skilled in the art.

Further referring to FIG. 4, final stage of the offline directory publishing system 120 takes the collection of HTML pages and formats them for delivery to a directory user in a directory formatter, shown at 126. The directory formatter 126 can be a program that writes the directory to a CD, shown at 127. The directory formatter 126 can be a program that writes the directory to another type of computer readable medium such as a magnetic tape, a hard disk, or a nonvolatile semiconductor memory. The directory formatter 126 can be a program that emails the directory to a directory user. The directory formatter 126 can be a program that presents the directory for download from a web page. The directory formatter 126 can be any other computer implemented device, program, or process that helps present and deliver a set of web-browser readable files to a directory user.

Referring to FIG. 5, a directory page is shown at 180. The directory page 180 is an example of a page that a directory user might see when he/she is trying to find a particular product, service, organization, or individual. A directory page 180 can include a variety of different elements. For example, the directory page shown at 180 includes a banner, shown at 181. The directory page 180 typically includes a hierarchy of listings, including a parent link list, shown at 182 and a child link list, shown at 183. By clicking on a parent link item, such as “Adventure” in this example, a directory user can be presented with a list of child links, such as “Antarctic Winters”, Bob's Adventure Travel”, etc. The lowest level child links will connect a user to a listing page, such as that shown at 190 in FIG. 6. Further referring to FIG. 5, a directory page 180 can also include a search feature, shown at 184. A search feature allows a directory user to type in text and then press a “Search” button to find any pages in the directory that contain this text. An administrator using a control panel, an example of which is shown at 160 in FIG. 13, determines the structure and content of directory pages.

Referring to FIG. 6, a listing page is shown at 190. A listing page 190 is an example of a page that a directory user might view when clicking on the lowest level child link on a directory page, shown at 180 in FIG. 5. A listing page can include a variety of different elements. For example, the listing page shown at 190 includes:
a header, shown at 191;
a first text area, shown at 192;
a second text area, shown at 193;
a link to a page with supplemental questions and answers, shown at 194;
a link to a blog, shown at 195;
a web link, shown at 196;
a footer, shown at 197; and
a multimedia file, shown at 198.
   A listing page 190 can have any combination of elements arranged in any combination of ways that can be developed by anyone skilled in the art.

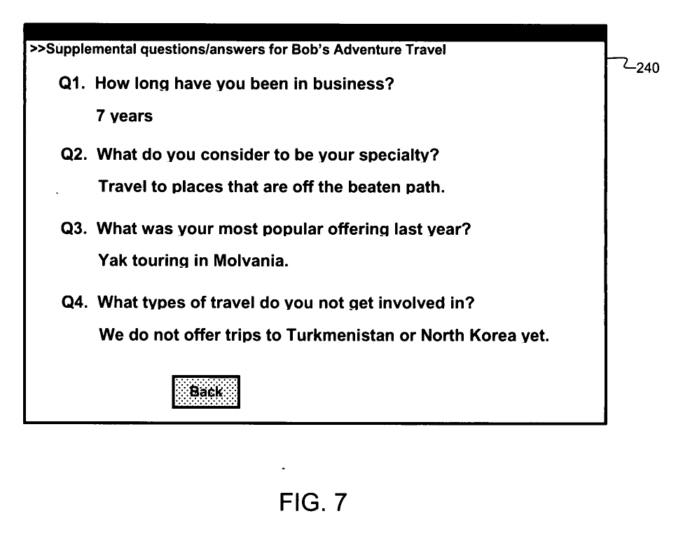

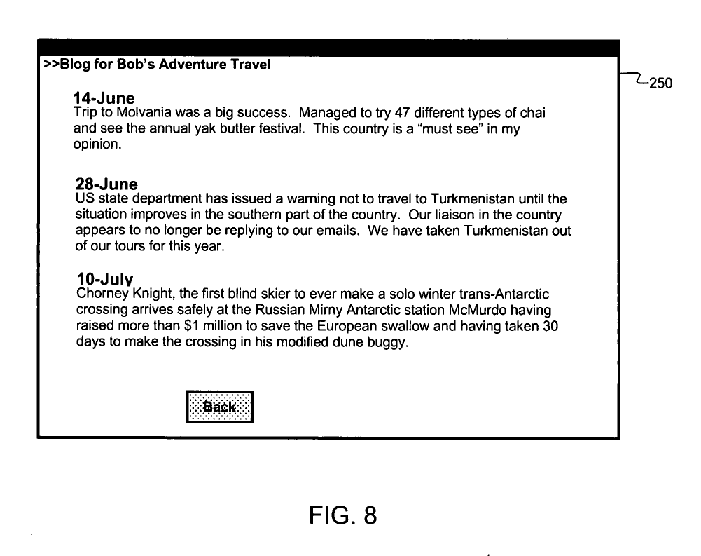

Referring to FIG. 7, a supplemental questions/answers page is shown at 240. The supplemental questions/answers page 240 appears when the link to a page with supplemental questions and answers, shown at 194 in FIG. 6 is clicked. Referring to FIG. 8, a blog page is shown at 250 in FIG. 8. The blog page 250 appears when the link to a page blog page, shown as 195 in FIG. 6 is clicked.

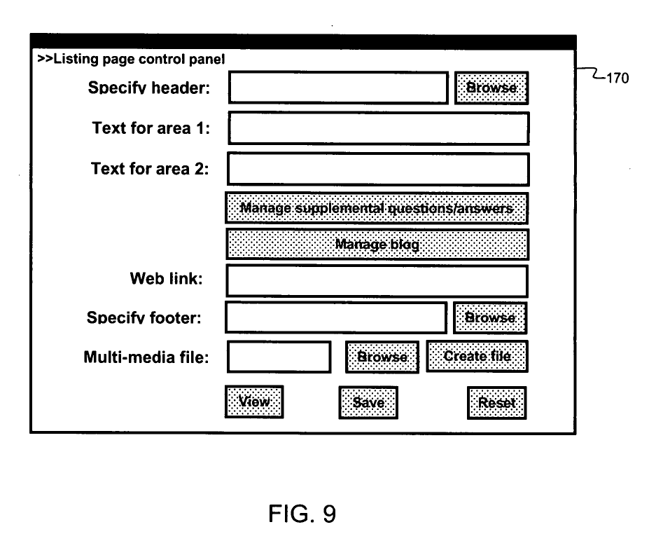

Referring to FIG. 9, a sample listing subscriber control panel page is shown at 170. The listing subscriber control panel page 170 allows a listing subscriber to click boxes and input text to create the listing page that was shown at 190 in FIG. 6. This makes it very easy for a computer novice to make their own listing page, 190 in FIG. 6. The sample listing control panel page 170 includes clickable button links to a multimedia file authoring control panel page, shown at 200 in FIG. 10, a blog management panel page, shown at 210 in FIG. 11, and a supplemental questions/answers input panel page shown at 220 in FIG. 12.

Referring to FIG. 10, a multimedia file authoring control panel page is shown at 200. This multimedia file authoring control panel page 200 allows a listing subscriber to specify the predefined template 131 in FIG. 3, the input files 132 in FIG. 3, and the output file parameters 133 in FIG. 3 needed to generate the multimedia file or files to be used on a listing page 198 in FIG. 6.

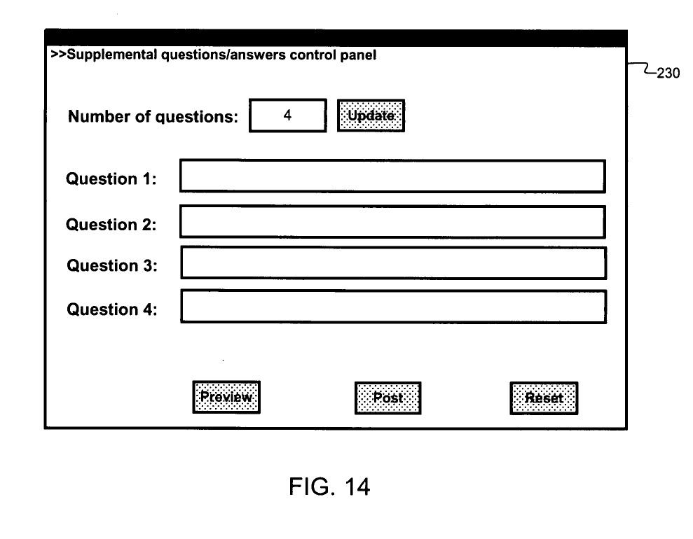

Referring to FIG. 12, a supplemental questions/answers input panel page is shown at 220. This input panel page 220 allows a listing subscriber to specify answers to questions relevant to this directory. The questions and answers will be visible to a directory user. The questions are specified by an administrator in a supplemental questions/answers control panel page shown at 230 in FIG. 14. The combination

Referring to FIG. 13, an administrator control panel page is shown at 160. The administrator control panel page 160 allows an administrator to set up the structure and appearance of a directory. The administrator control panel page 160 also allows an administrator to set up listing subscribers and manage billing and payments. The control panel page shown at 160 illustrates some of the feature areas that an administrator can manage. Each of these items includes a button that can be clicked to get to one or more detailed screens in which an administrator can point and click to specify parameters, files, and content in the same way that FIG. 9,

FIG. 10, FIG. 11, and FIG. 12 allow a listing subscriber to specify parameters, files and content. The typical layout of these screens and their implementation is well understood by anyone skilled in the art. FIG. 14 serves as an example of one of these screens.

Referring to FIG. 14, a supplemental questions/answers control panel page is shown at 230. This screen, in conjunction with FIG. 10 and FIG. 7 illustrates how an administrator can specify questions that are then answered by a listing subscriber FIG. 12 and visible to a directory user FIG. 7. Thus multiple levels in the directory system management hierarchy are involved in creating the content of the supplemental questions/answers page shown at 240 in FIG. 7.

Referring to FIG. 15, a reseller control panel page is shown at 150. The reseller control panel page 150 allows a reseller to set up administrators and lower levels of resellers. The control panel page shown at 150 illustrates some of the feature areas that a reseller can manage. Each of these items includes a clickable button to get to one or more detailed screens in which a reseller can point and click to specify parameters, files, and content in the same way that FIG. 9, FIG. 10, FIG. 11, and FIG. 12 allow a listing subscriber to specify parameters, files and content. The typical layout of these screens and their implementation is well understood by anyone skilled in the art.

Referring to FIG. 16, a system manager control panel page is shown at 140. The system manager control panel page allows a system manager to set up resellers and administrators as well as a number of capabilities to control parameters for all directory systems. The control panel page shown at 140 illustrates some of the feature areas that a reseller can manage. Each of these items includes a clickable button to get to one or more detailed screens in which a reseller can point and click to specify parameters, files, and content in the same way that FIG. 9, FIG. 10, FIG. 11, and FIG. 12 allow a listing subscriber to specify parameters, files and content. The typical layout of these screens and their implementation is well understood by anyone skilled in the art

While the principles of the invention have been described above in connections with specific apparatuses and methods, it is to be clearly understood that this description is made only by way of example and not as limitation on the scope of the invention.

1. An integrated multimedia directory system comprising:
a multiplicity of directory user accessible multimedia listing pages and at least one directory page;
a multiplicity of point and click control panel pages for a hierarchy of directory management levels comprising a listing subscriber control panel page, an administrator control panel page, and a system manager control panel page wherein said listing subscriber control panel page further comprises a multimedia file input feature;
an online version that comprises a web server and a database and an offline version that comprises a linked collection of pages directly readable in a web browser on an offline computing applicance;
a server-side offline directory publishing system wherein said server-side offline directory publishing system can be used to create said offline version;
and a multimedia file authoring system wherein said multimedia file authoring system comprises an input file reader, an output file parameter interpreter, a multimedia file generator, and a file sender.

2. The system of claim 1 wherein said multimedia file authoring system further comprises a pre-defined template.

3. The system of claim 2 wherein said hierarchy of control panels further comprises a reseller control panel and wherein said reseller control panel can be used to manage at least on additional tier of reseller control panels and administrator control panels.

4. The system of claim 3 wherein said offline version is published on a digital storage medium from the group comprising an optical disk, a magnetic disk, a magnetic tape, and a semiconductor memory device.

5. The system of claim 3 wherein said offline version is distributed via the internet.

6. The system of claim 3 further comprising a blog feature.

7. The system of claim 6 further comprising a blog management panel page.

8. The system of claim 3 further comprising a question and answer management feature.

9. The system of claim 8 wherein said question and answer management feature comprises a question and answer page, a questions and answers input panel page, and a questions and answers control panel page.

10. The system of claim 3 wherein multimedia comprises video.

11. The system of claim 3 wherein the fees for using said system comprise a monthly subscription.

12. The system of claim 3 wherein the fees for using said system comprise a payment based on the number of visitors to at least one page on said system.

13. A computer-implemented method for producing a multimedia directory, the method comprising the steps of:
producing a multiplicity of multimedia files;
producing a multiplicity of directory user accessible multimedia listing pages;
producing at least one directory page;
producing a listing subscriber control panel page;
producing an administrator control panel page;
producing a system manager control panel page wherein said system manager control panel page can add an administrator and assign administrator rights;
making said multimedia directory available over the internet; and
publishing said multimedia directory for offline computing appliances.

14. The method of claim 13 further comprising producing a reseller control panel page wherein said reseller control panel wherein said reseller control panel page can add an administrator and can assign administrator rights and said reseller control panel page can add a reseller.

15. The method of claim 13 wherein producing comprises using a point and click interface.

16. The method of claim 13 further comprising tracking the amount of visitors to said directory user accessible multimedia pages;

17. The method of claim 13 where publishing comprises a digital storage medium from the group comprising an optical disk, a magnetic disk, a magnetic tape, and a semiconductor memory device.

18. The method of claim 13 where publishing comprises sending a single file over the internet.

19. The method of claim 13 wherein multimedia comprises video.

20. A computer-readable medium having computer-executable instructions for performing the computer-implemented method of claim 13.
